(19) United States
(12) Patent Application Publication
(10) Pub. No.: US 2023/0191349 A1
(43) Pub. Date: Jun. 22, 2023

(54) A SYSTEM AND A METHOD FOR PRODUCING CATALYTICALLY TREATED PYROLYTIC VAPOR

(71) Applicants: Valmet Technologies Oy, Espoo (FI); Neste Oyj, Espoo (FI)

(72) Inventors: Matti YLITALO, Tampere (FI); Teppo RIIHIMÄKI, Tampere (FI)

(21) Appl. No.: 17/926,066

(22) PCT Filed: Jun. 2, 2021
(86) PCT No.: PCT/FI2021/050408

§ 371 Date: Nov. 17, 2022

(30) Foreign Application Priority Data
Jun. 15, 2020 (FI) 20205620

(51) Int. Cl. B01J 6/00; B01J 35/02; B01J 38/00; B01J 29/04; B01J 8/02; B01D 53/24; B01J 19/00

(52) U.S. Cl. CPC B01J 6/008; B01D 53/24; B01J 8/02; B01J 19/0066; B01J 29/04; B01J 35/023; B01J 38/00; B01J 2219/00765; B01J 2219/00894

(57) ABSTRACT

A system for producing catalytically treated pyrolytic vapor.The system comprises a pyrolysis reactor (100) configured to produce pyrolytic vapor and a catalytic reactor (200) limiting abed area (B) into which a fluidized catalyst bed is configured to form in use. The catalytic reactor (200) comprises a static mixer (300) configured to spread the particulate catalyst within the bed area (B). Thus, the catalytic reactor (200) is configured to produce a mixture of the particulate catalyst and the catalytically treated pyrolytic vapor from the pyrolytic vapor. A method for producing catalytically treated pyrolytic vapor. The method comprises producing pyrolytic vapor and allowing at least a clean part of the pyrolytic vapor to chemically react in the presence of the particulate catalyst to produce a mixture of the particulate catalyst and catalytically treated pyrolytic vapor. The method comprises mixing, in the bed area, the pyrolytic vapor and the particulate catalyst with a static mixer.

### TECHNICAL FIELD

The invention relates to a method for producing catalytically treated pyrolytic vapor, the pyrolytic vapor obtained from pyrolysis of pyrolyzable material(s), such as biomass and/or residue derived material. The invention relates to a system for performing the method. The invention relates to a method for producing pyrolytic product of high quality, the pyrolytic product being widely applicable, e.g. as substitute for fossil fuels and/or as a feed for biochemical production.

### BACKGROUND

Pyrolysis is a process, wherein some carbon comprising material is heated in a pyrolysis reactor at an elevated temperature and in the absence of free oxygen (O₂) to form pyrolytic vapors. Char is produced as a side product. Depending of the process details, more or less char may be comprised by the pyrolytic vapors. The elevated temperature of pyrolysis typically ranges in between 400° C. and 700° C. Pyrolytic vapors typically comprise condensable vapors, which can be condensed to crude condensate comprising pyrolytic oil. Such pyrolytic oil typically has high acidity and high viscosity, and it is relatively unstable, these properties being a result of e.g. oxygen being bound to the constituents.

To improve properties of the pyrolytic oil, it is known to treat the pyrolytic vapors catalytically in a multi-layered static catalyst bed reactor. In such a solution, pyrolytic vapors are introduced at a top of a multi-layered catalyst bed reactor into the catalyst bed reactor. The pyrolysis vapor stream passes downwards through each catalyst bed, in sequence from the top to a bottom in the multi-layer catalyst bed reactor, whereby catalytically treated pyrolytic vapor is obtained.

However, catalyst materials need to be regenerated or replaced from time to time. This may be e.g. because impurities adhere onto the catalyst material and need to be removed therefrom e.g. by oxidizing. In the alternative, the catalyst may be replaced by fresh catalyst material. However, this is not preferred due to operational costs. The static catalyst bed(s) of the catalyst reactor of prior art cannot be used while regenerating or replacing the catalyst. This implies interruption to the process. An interruption to a process implies decreased efficiency.

### SUMMARY

It has been found that the catalyst can be replaced or regenerated without interrupting the process, if a fluidized catalyst bed is used to catalytically treat the pyrolytic vapors. In a fluidized bed catalytic reactor, new catalyst or regenerated catalyst is fed to the reactor, and used catalyst is simultaneously withdrawn therefrom. However, while studying the operation of a fluidized bed catalytic reactor, the inventors observed a tendency of the catalyst material to accumulate on walls of the catalytic reactor. This phenomenon reduces the effective area between the catalyst and the pyrolytic vapor thereby imposing longer reaction times or poorer quality of the catalytically treated pyrolytic vapor. In addition, this phenomenon causes the flow profile to be uneven thereby reducing the reaction time available. The inventors have further found that better mixing of the particulate catalyst material and the pyrolytic vapor can be achieved by using a static mixer. This improves the quality of the catalytically treated pyrolytic vapor without the need of longer reaction times. Or conversely, this provides the same quality with a shorter reaction time, i.e. smaller equipment. Since the materials flow in the catalytic reactor, a long reaction time indicates a long low path.

The system according to the invention is disclosed in more specific terms in claim 1. The method according to the invention is disclosed in more specific terms in claim 13.

### BRIEF DESCRIPTION OF THE DRAWINGS

FIGS. 1a to 1d show systems for producing catalytically treated pyrolytic vapor,

FIGS. 2a to 2d show systems for producing catalytically treated pyrolytic vapor and crude condensate therefrom,

FIG. 3a shows, in a side view, an embodiment of a static mixer,

FIG. 3b shows, in a perspective view, the static mixer of FIG. 3a,

FIG. 3c shows, a cross sectional view, as seen from top, of the static mixer of FIG. 3a

FIG. 3d shows, in another side view, the static mixer of FIG. 3a,

FIG. 3e shows, in a perspective view, an embodiment of a static mixer,

FIG. 4a shows, in a side view, an embodiment of a static mixer,

FIG. 4b shows, a cross sectional view, as seen from top, of the static mixer of FIG. 4a,

FIG. 5a shows, in a side view, an embodiment of a static mixer,

FIG. 5b shows, a cross sectional view, as seen from top, of the static mixer of FIG. 5a,

FIG. 6 shows an embodiment of a system for producing catalytically treated pyrolytic vapor and crude condensate therefrom, wherein a furnace is configured to burn pyrolysis residue, and

FIG. 7 shows an embodiment of a system for producing catalytically treated pyrolytic vapor, the embodiment comprising multiple catalytic reactors.

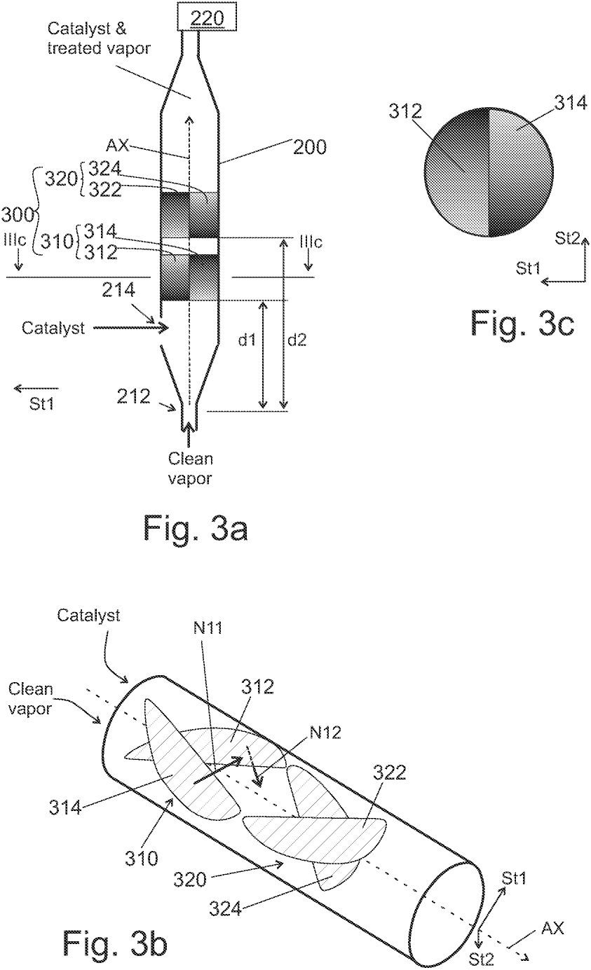

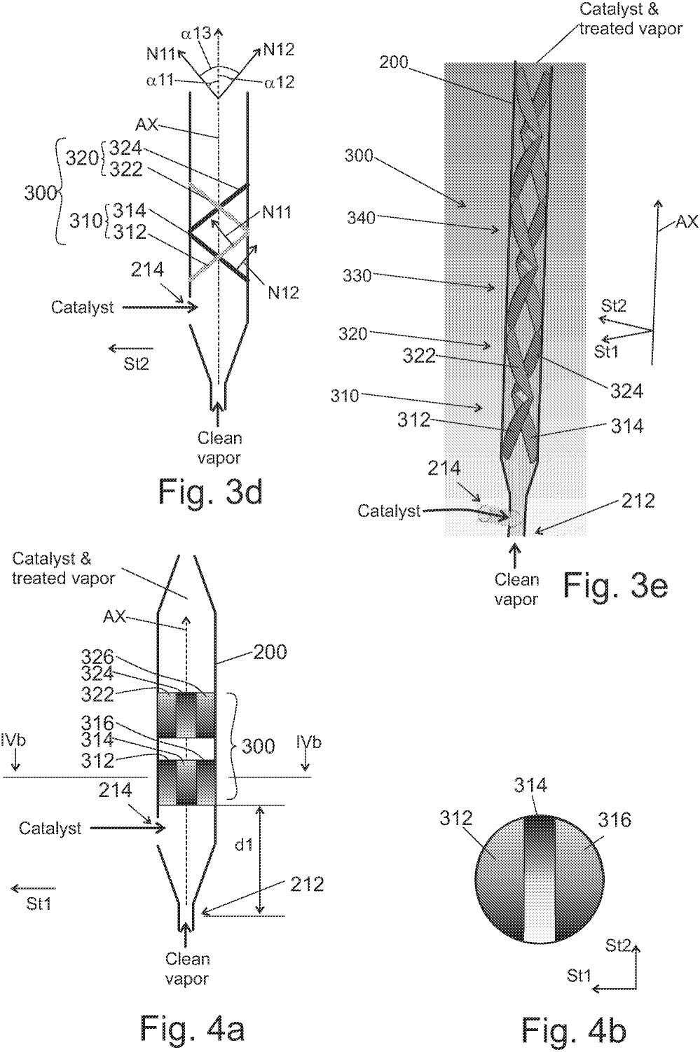

In the figures, where applicable, AX denotes an axial direction of a catalytic reactor. In use, the axial direction may be substantially vertical. The directions St1 and St2 denote two orthogonal directions transverse to the axial direction AX. In FIGS. 3a, 3c, 3d, 4a, and 4b, concerning the items 312, 314, 322, and 324, a darker color indicates a distance further away from the reader. This applies also to the items 316 and 326 in FIGS. 4a and 4b.

### DETAILED DESCRIPTION

Pyrolytic vapors are produced by pyrolyzing pyrolyzable material. In this description, pyrolyzable material refers to material that comprises carbon. Preferably, pyrolyzable material comprises at least 25 w% (percentage by weight) carbon, more preferably at least 40 w% carbon, in terms of dry mass. Pyrolyzable material may comprise or consist of biomass. Pyrolyzable material may comprise polymer materials, e.g. plastics. Pyrolyzable material may comprise or consist of residue-derived material, such as refuse-derived fuel (RDF) and/or solid recovered fuel (SRF). In general, SRF is a special type of RDF, and SRF has a standardized quality.

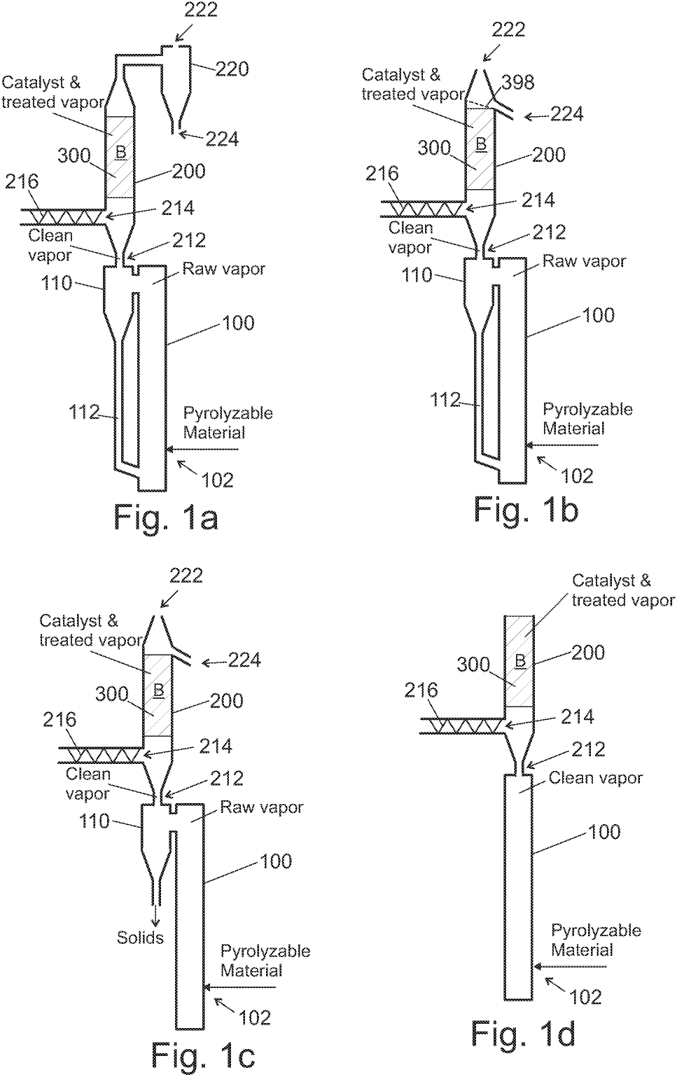

Referring to FIGS. 1a to 1d, the pyrolyzable material is pyrolyzed by feeding the pyrolyzable material into a pyrolysis reactor 100 and heating the pyrolyzable material to a temperature from 400° C. to 700° C. to vaporize vaporizable compounds of the pyrolyzable material. In this way, pyrolytic vapors are produced. The pyrolytic vapors, optionally after cleaning, are catalytically treated in a catalytic reactor 200 by using a catalyst.

Referring to FIGS. 1a to 1c, the pyrolysis reactor 100 may be a fluidized bed pyrolysis reactor. Because of fluidizing, some of bed material and/or char flow with the raw pyrolytic vapor (in Figs. “Raw vapor”). In order not to contaminate the catalyst of the catalytic reactor 200, in such a case, the raw pyrolytic vapor is cleaned in a first cyclone 110 of the pyrolysis reactor 100. Thus, in these embodiments, the pyrolysis reactor 100 comprises the first cyclone 110. In these embodiments, the pyrolysis reactor 100 is configured to produce clean (i.e. cleaned) pyrolytic vapor by the first cyclone 110. In FIGS. 1a to 1c, such cleaned pyrolytic vapor is referred to as “Clean vapor”. The cleaned vapor need not be completely free from impurities. Referring to FIG. 1d, in case the pyrolysis reactor is not of the fluidized bed type, it is possible that sufficiently clean pyrolytic vapor (in FIG. 1d “Clean vapor”) is produced directly in the pyrolysis. Thus, the first cyclone may not be needed. The upper parts of the catalytic reactor 200 in FIG. 1d are not shown, and depending on the details of the process, the upper part in the embodiment of FIG. 1d could correspond to the upper part of FIG. 1a or FIG. 1b. The cleaned pyrolytic vapor may be referred to as clean pyrolytic vapor, or in short, pyrolytic vapor.

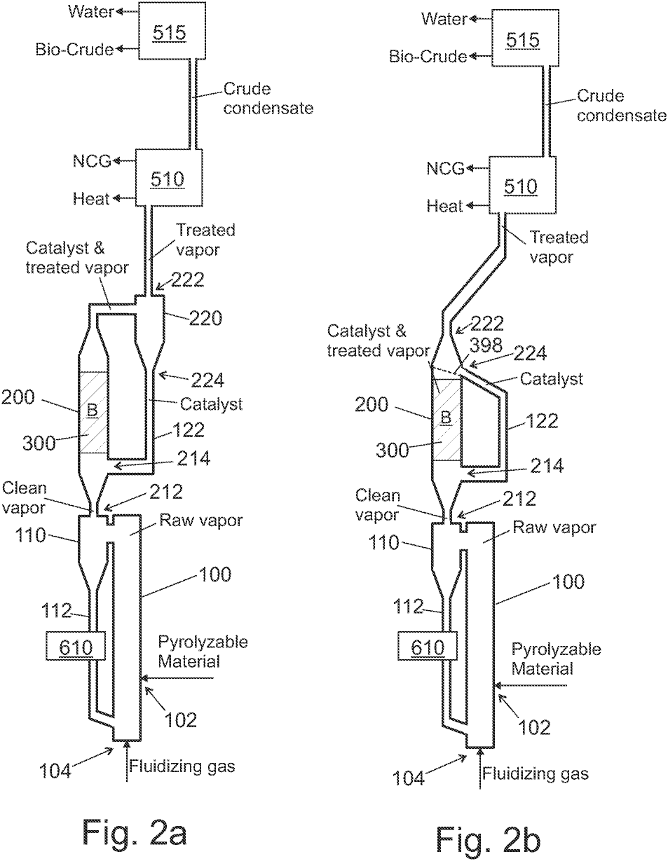

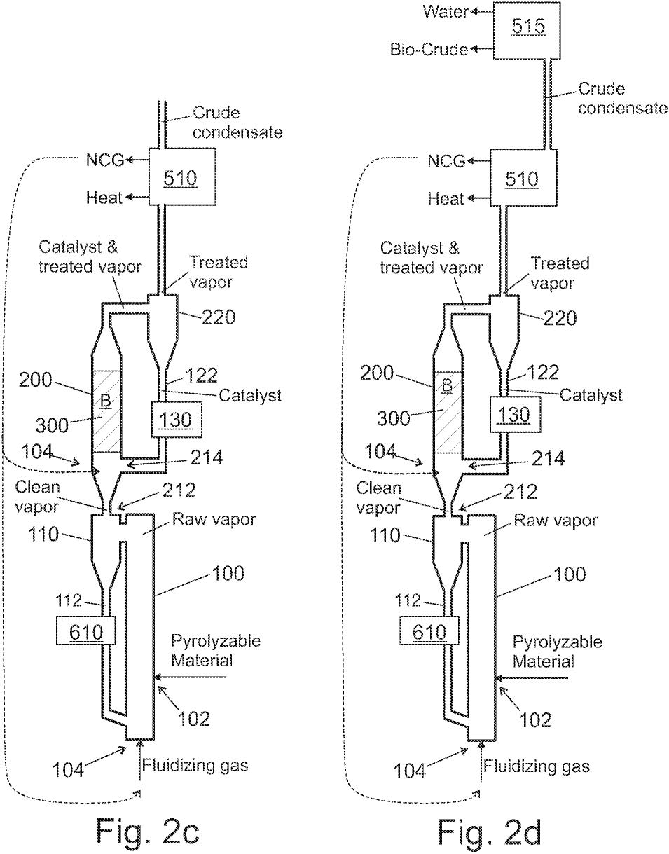

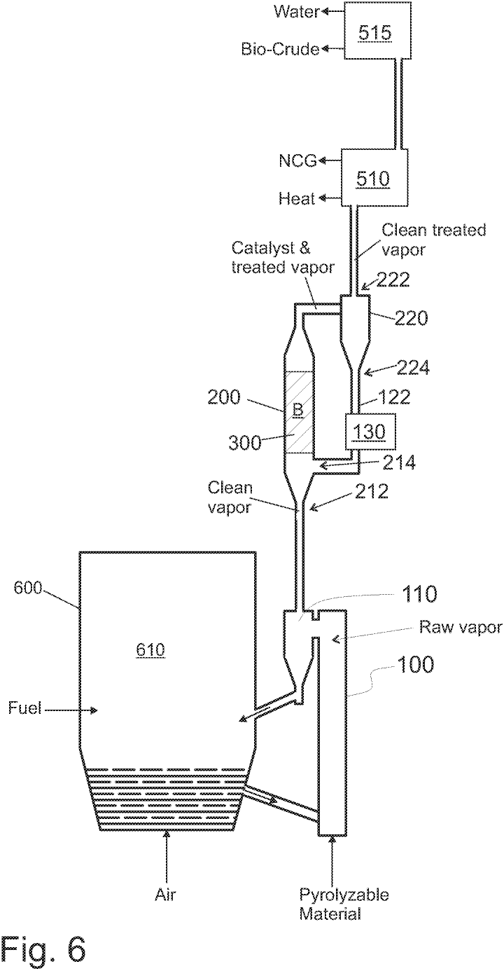

Thus, a system configured to produce catalytically treated pyrolytic vapor comprises the pyrolysis reactor 100. The pyrolysis reactor 100 is configured to produce clean pyrolytic vapor. The pyrolysis reactor 100 comprises an inlet 102 for letting in pyrolyzable material into the pyrolysis reactor 100. Correspondingly, a method for producing catalytically treated pyrolytic vapor comprises producing clean pyrolytic vapor. If needed, e.g. if the pyrolysis reactor 100 is of the fluidized bed type, the pyrolysis reactor 100 comprises the first cyclone 110 configured to produce the clean pyrolytic vapor from raw pyrolytic vapor. A corresponding embodiment comprises cleaning raw pyrolytic vapor to produce cleaned (i.e. clean) pyrolytic vapor. When the first cyclone 110 is used, some of the solids of the raw pyrolytic gas is removed. The solids, which may comprise bed material of the pyrolysis reactor 100, may be, but need not be, conveyed back to an interior of the pyrolysis reactor 100 through the channel 112 (see FIGS. 1a and 1b). However, as detailed in connection with FIG. 1c, the separated solids (not necessarily bed material) need not be conveyed back to pyrolysis. Moreover, as detailed in connection with FIGS. 2a to 2d and 6, the bed material may be conveyed via a furnace 610 back to the pyrolysis reactor 100.

A clean part of the pyrolytic vapor (“Clean vapor” in the FIGS. 1a to 2d) is catalytically treated in a catalytic reactor 200 by using a fluidized bed of particulate catalyst. The clean part may comprise all the pyrolytic vapor or the cleaned part of the raw pyrolytic vapor, as detailed above. Thus, the method comprises feeding at least a clean part of the pyrolytic vapor, and particulate catalyst into the catalytic reactor 200. The fluidized bed is formed in a bed area B of the reactor 200. Because of the fluidizing operating principle of the catalytic reactor 200, in an embodiment, the clean pyrolytic vapor and the particulate catalyst are configured to flow substantially upwards in the bed area B or the catalytic reactor 200. Moreover, to improve fluidizing of the particulate catalyst in the bed area B, an embodiment of the system comprises a third inlet 104 (see FIGS. 2a to 2d) for letting in fluidizing gas to increase flow of gas or gases in the bed area B of the catalytic reactor 200. As depicted in FIGS. 2a and 2b, in an embodiment, the third inlet 104 is configured to let the fluidizing gas in to the pyrolysis reactor 100. However, as indicated in FIGS. 2c and 2d, in an embodiment a third inlet 104 is configured to let the fluidizing gas in to the catalytic reactor 200. Moreover, the system may comprise multiple inlets 104 for letting in fluidizing gas to increase flow of gas or gases in the bed area B of the catalytic reactor 200, as depicted in FIGS. 2c and 2d.

In order to catalytically treat the clean pyrolytic vapor, the clean pyrolytic vapor and particulate catalyst are fed into a catalytic reactor 200. As indicated above, the catalytic reactor 200 is of the fluidized bed type in order to enable regeneration and/or replacement of the catalyst while operating the catalytic reactor 200. Thus, the method comprises fluidizing the clean pyrolytic vapor and the particulate catalyst in a bed area B of the catalytic reactor 200. The method further comprises allowing the pyrolytic vapor to chemically react in the presence of the particulate catalyst to produce a mixture of the particulate catalyst and catalytically treated pyrolytic vapor. Such a mixture is denoted by “Catalyst & treated vapor” in FIGS. 1a to 1d, 2a to 2d, 3a, 4a, 5a, and 6.

As for the term particulate catalyst, the particulate catalyst consists of particles comprising some catalyst material. The particulate catalyst is in solid form at a temperature of the catalysis reaction, which will be detailed later. A sufficiently small particle size has at least two technical effects: First, a surface between the catalyst and the pyrolytic vapor is high, which implies high reaction efficiency. Second, fluidizing the catalyst bed is easier, when the particles of the catalyst are small. Therefore, in an embodiment, an average particle diameter by volume of the particulate catalyst is at most 1 mm or at most 500 µm . However, in order to remove the used catalyst from the process, a particle size of the particulate catalyst should not be too small. Thus, in an embodiment, the average particle diameter by volume of the particulate catalyst is from 1 µm to 1000 µm, preferably from 50 µm to 300 µm. In an embodiment, the particulate catalyst comprises zeolite. More preferably, the particulate catalyst comprises zeolite and the average particle diameter by volume of the particulate catalyst is from 1 µm to 1000 µm, preferably from 50 µm to 300 µm. As for the term “diameter”, herein the term “diameter” refers to an aerodynamic diameter of the catalyst particles. In general, the aerodynamic diameter of an arbitrary particle is equal to the diameter of a spherical particle, with a density of 1 g/cm³, which has the same inertial properties in the pyrolytic vapors as the arbitrary particle.

The catalytic reactor 200 limits the bed area B into which the fluidized catalyst bed is configured to form in use. The catalytic reactor 200 is configured to produce a mixture of catalyst and catalytically treated pyrolytic vapor from the clean pyrolytic vapor. In the bed area B, at least some of the pyrolytic vapor reacts chemically in the presence of the particulate catalyst to produce a mixture of the particulate catalyst and catalytically treated pyrolytic vapor. Thus, the catalytic reactor 200 is configured to produce a mixture of catalyst and catalytically treated pyrolytic vapor from the clean pyrolytic vapor. In order to form the mixture, the catalytic reactor 200 comprises a first inlet 212 for letting in at least a clean part of the pyrolytic vapor into the catalytic reactor 200. The at least clean part of the pyrolytic vapor may refer to clean vapor obtainable from pyrolysis without cleaning or to a cleaned part of the raw pyrolytic vapor. The catalytic reactor 200 comprises a second inlet 214 for letting in particulate catalyst into the catalytic reactor 200. The second inlet 214 may be arranged below the bed area B or at a lower part of the bed area B. If needed, the catalytic reactor 200 may comprise multiple inlets for letting in particulate catalyst into the catalytic reactor 200, one of them being the second inlet 214.

As indicated above, in use, the vapor and the catalyst flow substantially upwards in the bed area B of the catalytic reactor 200, and the catalyst becomes used. The thus used particulate catalyst may be collected from the catalytic reactor 200. In an embodiment, the catalytic reactor 200 comprises a particle separator for separating the particulate catalyst from the catalytically treated pyrolytic vapor. The particle separator for separating the particulate catalyst may be arranged above the bed area B or in an upper part of the bed area B.

Depending on process details, as will be detailed below, the catalytic reactor 200 may comprise, as the particle separator for separating the particulate catalyst from the catalytically treated pyrolytic vapor, a second cyclone for 220 for separating the particulate catalyst from the catalytically treated pyrolytic vapor (see e.g. FIGS. 1a, 2a, and 3a). However, a perforated plate 398 may be used as the particle separator (see e.g. FIGS. 1b, 2b, and 5a). In both cases, the catalytic reactor 200 comprises a first outlet 222 for letting out catalytically treated pyrolytic vapor (“Treated vapor” in FIGS. 2a to 2d) and a second outlet 224 for letting out particulate catalyst (“Catalyst” in FIGS. 2a to 2d). In a preferable embodiment, the catalytic reactor 200 comprises the second cyclone 220. The second cyclone 220 is configured to separate the particulate catalyst from the mixture of the particulate catalyst and catalytically treated pyrolytic vapor. Moreover, in this embodiment, the second cyclone 220 comprises the first outlet 222 and the second outlet 224.

In a fluidized bed reactor, such as in the bed area B of the catalytic reactor 200 (at least if a mixer 300 is not used), the bed material may start to accumulate at one location in use, typically near the walls of the reactor. Moreover, the fluidizing gas tends to bypass this location, since dense areas imply high flow resistance. In this way, sometimes dense bed areas with high catalyst concentration are observed, if a mixer 300 is not used. Catalytic conversion at this location is minimal, as the pyrolytic vapor bypasses this location. In addition, the flow velocity nearby this area exceeds a design velocity, since the dense area restricts the flow, which also reduces the efficiency of the catalytic conversion.

In order to spread the particulate catalyst more evenly in the bed area B of the catalytic reactor 200 and in this way improving the quality of the catalytically treated pyrolytic vapor, the catalytic reactor 200 comprises a static mixer 300. The static mixer 300 is configured to spread the particulate catalyst of the catalyst bed within the bed area B of the catalytic reactor 200. In particular, the static mixer 300 is configured to move such particulate catalyst that tends to accumulate on walls of the catalytic reactor 200 towards inner parts if the bed area B of the catalytic reactor 200. Correspondingly, the method comprises mixing the clean pyrolytic vapor and the particulate catalyst using a static mixer 300 in the bed area B of the catalytic reactor 200.

The static mixer 300 is a device for the continuous mixing of fluid materials, without moving components. In the art, the term “static mixer” is used interchangeably with terms like “static mixing device” and “motionless mixer”. In general, a static mixer comprises a plate or plates or other twisted elements for guiding the flow of the fluids and to generate turbulence so as to mix the fluids. In the present case, the fluids to be mixed are the fluidized particulate catalyst and the clean pyrolytic vapor. A purpose of the static mixer 300 is to increase turbulence and thereby to improve mixing and to decrease reaction time for the catalysis reaction. From the operational point of view a target would be that within a cross section of the catalytic reactor 200, a concentration of the catalyst particles would be even. While this is rarely achieved, it has been noticed that the static mixer 300 levels out the catalyst concentration within the catalytic reactor 200.

Typically, the catalytic reactions of the clean pyrolytic vapor occur at an elevated temperature close to the temperature within the pyrolysis reactor 200. For example, in an embodiment of the method, a temperature in the catalytic reactor 200 is from 400° C. to 700° C. The catalysis may be, but need not be pressurized. In an embodiment, pressure in the catalytic reactor 200 is less than 2 bar(a) and the temperature in the catalytic reactor 200 is from 400° C. to 700° C. Herein the unit bar(a) refers to absolute pressure instead of gauge pressure. Therefore, the static mixer 300 needs to withstand such high temperatures. Typically many metals can withstand high temperatures. Thus, in an embodiment, the static mixer 300 is made of a metal capable of withstanding a temperature of at least 400° C. In general, a static mixer 300 may comprise helical rods, twisted plates, plates having complex shape of apertures, or fins, to name a few possible constructions.

Some embodiments of a static mixer 300 are depicted in FIGS. 3a to 5b. As indicated above, the static mixer 300 is configured to prevent accumulation of the particulate catalyst on the walls of the bed area B of the catalytic reactor 200. Preferably, the static mixer has a low flow resistance, i.e. it produces only a minor pressure drop in between the regions before and after the static mixer 300. Preferably, the static mixer 300 is configured to produce, in use, a pressure drop of at most 2 kPa, more preferably at most 1 kPa. The pressure drop refers to a pressure difference between the regions before and after the static mixer 300.

In the embodiments of FIGS. 3a to 5b, within the bed area B, the clean pyrolytic vapors are configured to flow, on average, in an axial direction AX of the catalytic reactor 200. The axial direction AX may be substantially vertical. The axial direction AX is directed from an inlet section of the bed area B to an outlet section of the bed area B. Moreover, the static mixer 300 comprises a primary first baffle plate 312, 392. Herein the term “plate” refers to a planar object, i.e. a flat object. Using planar plates, as opposed to more complex shapes has the benefit that a reasonably sturdy static mixer 300 is easily to manufacturable. The term “baffle” indicates that a purpose of the plate is to guide the flow of the pyrolytic vapor.

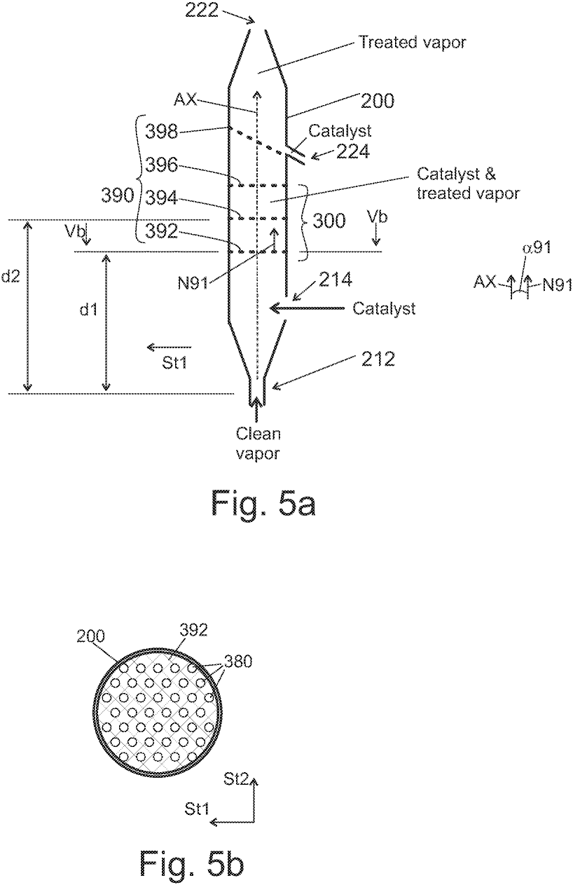

A primary first angle (α11, α91) is arranged between a normal (N11, N91) of the primary first baffle plate (312, 392) and the axial direction AX. In order to mix the catalyst and the clean pyrolytic vapor, in an embodiment, the primary first angle (α11, α91 ) is at most 85 degrees, preferably at most 80 degrees, as readable from FIGS. 3d and 5a. Such an angle implies that the primary first baffle plate 312, 392 generates turbulence; e.g. by changing the direction of flow of the material in the bed area or by changing the velocity of the flow (e.g. near apertures).

A purpose of the primary first baffle plate 312, 392 is to move the particulate catalyst from the walls of the bed area B towards an interior of the bed area B. Thus, in a preferable embodiment, the primary first baffle plate (312, 392) extends from a wall of the bed area B of the catalytic reactor 200 to an interior of the bed area B, i.e. towards a central axis (see reference AX) of the bed area B.

Moreover, preferably, the primary first baffle plate 312, 392 is arranged such that a full cross section of the bed area B of the catalytic reactor 200 is covered by a set of baffle plates, wherein the set of baffle plates comprises the primary first baffle plate 312, 392. The term “cover” refers to an area covered by the normal projections of the baffle plates of the set of baffle plates to the cross section of the bed area. Reference is made to FIGS. 3c, 4b, and 5b. This has the effect that the bed area B is free from such flow paths, wherein the vapors could flow from an inlet area to an outlet area without being guided by a baffle plate.

Referring more specifically to FIGS. 3a to 4b, in an embodiment, the static mixer 300 comprises a primary pair 310 and a secondary pair 320 of baffle plates. Each pair (310, 320) comprises a first baffle plate (312, 322) and a second baffle plate (314, 324). The baffle plates are shown as a side view in FIGS. 3a and 3d, and as a top view in FIG. 3c. Therein, a dark color indicates a distance far from the reader, and a light color indicates a distance closer to the reader. Reference is made also to FIG. 3b. As indicated in FIGS. 4a and 4b, a pair 310 of baffle plates 312, 314 need not cover the full cross section of the bed area B, since the static mixer 300 may comprise further baffle plates such that the full cross section of the bed area is covered by a set of baffle plates. Moreover, the size and shape of the baffle plates may vary, depending on constructional details.

Referring more specifically to FIGS. 3a to 3d, in an embodiment, a cross section of the bed area B is circular. Referring to FIGS. 3a to 3d, in an embodiment, a primary pair 310 of baffle plates comprises a primary first semielliptical baffle plate 312 and a primary second semielliptical baffle plate 314. As depicted in FIGS. 3a to 3c, the baffle plates 312, 314 are disposed at an angle relative to each other. Moreover, the baffle plates 312, 314 are disposed at an angle from the axial direction AX of the catalytic reactor 200. Concerning the latter and with reference to FIG. 3d, a primary first angle α11 is arranged between a normal N11 of the primary first semielliptical baffle plate 312 and the axial direction AX; and a primary second angle α12 is arranged between a normal N12 of the primary second semielliptical baffle plate 314 and the axial direction AX. For definition of the normals N11 and N12, such a main surface of the baffles 312, 314 is considered that the angle α11 is less than 90 degrees and the angle α12 is less than 90 degrees, when AX is directed downstream (e.g. upwards vertical, see FIG. 3d). I.e. the main surface of the baffle plate 312, 314 that faces downstream is considered, even if the plates 312, 314 have an opposite surface, too. Moreover, preferably, the primary first angle α11 is from 30 to 85 degrees, e.g. from 45 to 80 degrees, and the primary second angle α12 is from 30 to 85 degrees, e.g. from 45 to 80 degrees. The lower limit for these angles ensures that a flow resistance is low, and the higher limit ensures sufficient mixing. Preferably the angles α11 and α12 are at least 45 degree to have reasonably low flow resistance even if the baffle plates are not provided with apertures. Concerning the angle between the baffle plates 312, 314, a primary third angle α13 is arranged between the normal of the primary first semielliptical baffle plate 312 and the normal of the primary second semielliptical baffle plate 314. The primary third angle α13 may be e.g. from 60 to 170 degrees, such as from 90 to 160 degrees. As detailed later, the primary first angle α11 and the primary second angle α12 may be much smaller provided that the baffle plates are provided with perforations.

Referring to FIGS. 4a and 4b, in an embodiment, a primary pair 310 of baffle plates comprises a primary first baffle plate 312 and a primary second baffle plate 314. As depicted in FIGS. 4a and 4b, the baffle plates 312, 314 are disposed at an angle relative to each other. Moreover, the baffle plates 312, 314 are disposed at an angle from the axial direction AX of the catalytic reactor 200. Concerning the latter, a primary first angle is arranged between a normal of the primary first baffle plate 312 and the axial direction AX; and a primary second angle is arranged between a normal of the primary second baffle plate 314 and the axial direction AX. Moreover, preferably, the primary first angle is from 45 to 85 degrees and the primary second angle is from 45 to 85 degrees, as discussed in connection with the embodiment of FIGS. 3a to 3d. The lower limit for these angles ensures that a flow resistance is low, and the higher limit ensures sufficient mixing. Concerning the former, a primary third angle is arranged between the normal of the primary first baffle plate 312 and the normal of the primary second baffle plate 314. The primary third angle may be e.g. from 60 to 170 degrees, such as from 90 to 160 degrees.

In FIGS. 3a to 3e and 4a and 4b, the baffle plates 312, 314 of a pair 310 of baffle plates are arranged at a same distance from the first inlet 212. However, in a more general static mixer, this needs not be so. However, preferably, at least a part of the primary first baffle plate 312 is arranged a same distance apart from the first inlet 212 as at least a part of the primary second baffle plate 314. In other terms, a primary distance d1 is arranged between the first inlet 212 and at least a part of the primary first baffle plate 312; and the primary distance d1 is arranged between the first inlet 212 and at least a part of the primary second baffle plate 314.

In FIGS. 3a to 3e and 4a and 4b, the static mixer 300 comprises a secondary pair 320 of baffle plates, the secondary pair 320 of baffle plates comprising a secondary first baffle plate 322 and a secondary second baffle plate 324. As depicted in FIGS. 3a to 4b, the baffle plates 322, 324 of the secondary pair 320 are disposed at an angle relative to each other. Moreover, the baffle plates 322, 324 are disposed at an angle from the axial direction AX of the catalytic reactor 200. The angles thus formed have been discussed in more detail in connection with the primary pair 310 of baffle plates mutatis mutandis.

The secondary pair 320 of baffle plates is arranged further away from the first inlet 212 than the primary pair 310 of baffle plates. Thus, a secondary distance d2 is arranged between the first inlet 212 and at least a part of the secondary first baffle plate 322; the secondary distance d2 is arranged between the first inlet 212 and at least a part of the secondary second baffle plate 324; and the secondary distance d2 is greater than the primary distance d1 (see FIG. 3a).

Moreover, the primary and secondary pairs of baffle plates 310, 320 are neighboring pairs of baffle plates. Consequently, in the FIGS. 3a to 4b, no baffle plate is arranged in between the secondary pair 320 of baffle plates and the primary pair 310 of baffle plates. In FIGS. 3a to 4b, the secondary first baffle plate 322 is arranged relative to the primary first baffle plate 312 only in the axial direction AX (and correspondingly not in a transversal direction) and the secondary second baffle plate 324 is arranged relative to the primary second baffle plate 314 only in the axial direction AX (and correspondingly not in a transversal direction). Moreover, in FIGS. 3a to 4b, the primary first baffle plate 312 is substantially unidirectional with the secondary second baffle plate 324 (see FIGS. 3b and 3e). In this way, the static mixer 300 has a reasonably turdy structure since the primary pair 310 of baffle plates can be fixed (e.g. welded) to the secondary pair 320 of baffle plates from an end of the baffle plate (see FIGS. 3d and 3e). In a corresponding manner, the primary second baffle plate 314 is substantially unidirectional with the secondary first baffle plate 312 (see FIGS. 3b and 3e). Moreover the first baffle plate (312, 322) of each pair (310, 320) of baffle plates can be fixed (e.g. welded) to the second baffle plate (314, 324) of the pair (310, 320) of baffle plates. This further improves sturdiness. Having a sturdy mixer 300 is beneficial, since the particulate catalyst material is solid material, even if fluidized.

As depicted in FIG. 3e, the static mixer 300 may comprise a tertiary pair 330 of baffle plates. The tertiary pair 330 of baffle plates is arranged further away from the first inlet 212 than the secondary pair 320 of baffle plates. Moreover, static mixer 300 may comprise a quaternary pair 340 of baffle plates. The quaternary pair 340 of baffle plates is arranged further away from the first inlet 212 than the tertiary pair 330 of baffle plates. Even if not shown in FIG. 4a, the static mixer 300 may comprise multiple pairs of baffle plates also in case, wherein the baffle plates are not semielliptical. As detailed below, it may be beneficial that the static mixer 300 extends throughout the bed area B of the catalytic reactor 200.

Referring to FIG. 3c, in an embodiment the baffle plates are semielliptical. In such a case a pair of baffle plates (e.g. 310, 320) preferably covers a full cross section of the bed area B. In more specific terms, a normal projection of the primary first baffle plate 312 onto a cross-sectional plane of the bed area B and a normal projection of the primary second baffle plate 314 onto the cross-sectional plane of the bed area B, in combination, cover the whole cross section of the bed area B (see FIG. 3c). In this way, a full cross section of the bed area B of the catalytic reactor 200 is covered by a set of baffle plates, wherein the set of baffle plates comprises the primary first baffle plate 312 (and further comprises the baffle plate 314). Preferably also a normal projection of the secondary first baffle plate 322 onto a cross-sectional plane of the bed area B and a normal projection of the secondary second baffle plate 324 onto the cross-sectional plane of the bed area B, in combination, cover the whole cross section of the bed area B.

Referring to FIG. 4b, in an embodiment the baffle plates are not semielliptical. As depicted in FIGS. 4a and 4b, the static mixer may comprise a primary third baffle plate 316, which is arranged a same distance d1 apart from the first inlet 212 as the primary first and primary second baffle plates 312, 314 (see FIG. 4a). Moreover, as depicted in FIG. 4b, the primary first 312, primary second 314, and primary third 316 baffle plates, in combination, cover a full cross section of the bed area B. In this way, a full cross section of the bed area B of the catalytic reactor 200 is covered by a set of baffle plates, wherein the set of baffle plates comprises the primary first baffle plate 312 (and further comprises the baffle plates 314 and 316).

Referring to FIGS. 5a and 5b, in an embodiment, the static mixer 300 comprises a baffle plate 392 (i.e. a primary first baffle plate) having apertures 380 configured to pass both the clean pyrolytic vapor and the particulate catalyst upwards. In the embodiment of FIG. 5a, a bubbling fluidized bed of the particulate catalyst may be formed on each one of the perforated primary first baffle plate 392, the perforated primary second baffle plate 394, and the perforated primary third baffle plate 396. Moreover, the higher flow velocity of the vapors at the perforations 380, compared to regions elsewhere, induces turbulence and mixing of the vapors with the particulate catalyst. In FIGS. 5a and 5b, the perforated primary baffle plates 392, 394, and 396 are substantially horizontal. Hence, in an embodiment, a normal N91 of the perforated primary first plate 392 forms an angle α91 of at most 10 degrees with the axis AX of the catalytic reactor 200. This concerns also the other primary baffle plates 394, 396 of FIG. 5a. Moreover, also the other primary baffle plates 394, 396 of FIG. 5a limits perforations 380 that are configured to pass both the clean pyrolytic vapor and the particulate catalyst.

Referring to FIG. 5a, a primary distance d1 is arranged between the first inlet 212 and at least a part of the primary first baffle plate 392, and a secondary distance d2 is arranged between the first inlet 212 and at least a part of the primary second baffle plate 394. Moreover, the secondary distance d2 is greater than the first distance d1.

As for a size an amount of the apertures 380, the size of the apertures 380 (see FIG. 5b) may be somewhat, but not too much, larger that the particle size of the particulate catalyst. This has the effect that the catalyst flows through the apertures 380 upwards, but does not flow downwards. Correspondingly, a bubbling fluidized bed may be formed on the perforated primary first baffle plate 392 (or plates, in case there are many). In addition to the size of the apertures, a flow velocity of the pyrolytic vapors through the apertures, compared to the flow velocity in between the baffles 392, 394 also affects how the catalyst flows. Correspondingly, the flow velocity should be substantially higher in the apertures 380 than elsewhere. The flow velocity is related to the total area of the apertures 380: the higher the total area, the lower the velocity.

Therefore, in a preferable embodiment, a total area limited by apertures 380 of a perforated baffle plate (e.g. the primary first baffle plate 392 or the primary second baffle plate 394) is from 30 % to 60 %, more preferably from 40 % to 50 % of a total cross sectional area of the bed area B of the catalytic reactor 200. The size of the apertures 380 is related to their number, taking into account their total area, as detailed above. A perforated baffle plate (e.g. the primary first baffle plate 392 or the primary second baffle plate 394, or each one individually) comprises multiple apertures 380. A purpose of the apertures 380 is to divide the flow of the pyrolytic vapor to several partial flows, wherein a flow velocity of these partial flows is increased in comparison to the combined flow in between the perforated plates. Therefore, a bubbling catalyst bed is formed evenly onto the perforated baffle plate(s) (392, 394). When a cross sectional area of the catalytic reactor is small, a smaller number of the perforations 380 may suffice. A number of apertures 380 in a perforated plate may be e.g. at least three, at least ten or at least fifty. However, the number may be significantly higher. Moreover, as depicted in FIG. 5b, a full cross section of the bed area B of the catalytic reactor 200 is covered by a set of baffle plates, wherein the set of baffle plates comprises the primary first baffle plate 312 (and no other plates). Herein the apertures 380 of the primary first baffle plate 312 are not considered to affect the covering of the cross section, since each one of the apertures 380 is reasonably small in the meaning discussed above.

FIG. 5a shows also a perforated secondary baffle plate 398, aligned at an angle relative to horizontal. Such a perforated secondary baffle plate may be used as the particle separator for separating the particulate catalyst from the catalytically treated pyrolytic vapor discussed above. However, whether a perforated plate 398 or a second cyclone 220 suffices as the particle separator depends e.g. on the flow velocity and catalyst particle size within the bed area B. A particle separator for separating the particulate catalyst from the catalytically treated pyrolytic vapor may comprise both a secondary perforated plate 398 and the second cyclone 220. Thus, the inclined perforated plate 398 may be used to withdraw the particulate catalyst from the catalytic reactor 200 as depicted in FIGS. 5a, 1b, and 2b.

The static mixer 300 may comprise a perforated horizontal baffle plate (392, 394, 396) and the non-horizontal primary first and primary second baffle plates 312, 314 (see FIGS. 3a to 4b) and, optionally, other baffle plates and/or more perforated plates. In addition or alternative, the baffle plates of the embodiments of FIGS. 3a to 4b may be provided with perforations to reduce flow resistance.

It has also been noticed that if the static mixer 300 is short compared to a length of the catalytic reactor 200, i.e. if the static mixer 300 is only located e.g. in a lower part of the catalytic reactor 200, the static mixer does not always generate turbulence to the full length of the catalytic reactor 200. To further improve the mixing, a longer static mixer 300 can be used. In an embodiment, a length of the static mixer 300 is at least 50 % or at least 65 % of a length of the bed area B of the catalytic reactor 200. In alternative terms, in an embodiment, a length of the static mixer 300 is at least 50 % or at least 65 % of a length of the catalytic reactor 200.

It has also been found that the poor mixing of catalyst and the pyrolytic vapors is more problematic in large catalytic reactors 200 than in smaller ones; and as indicated above, the mixing may be improved by the static mixer 300.

Therefore, in an embodiment, the catalytic reactor 200 comprises the static mixer and a cross-sectional area of the bed area B of the catalytic reactor is at least 7500 mm². The limit corresponds to reactor 200 having a circular cross section with an inner diameter of about 100 mm. Thus, in an embodiment, a cross section of the catalytic reactor 200 is circular and an inner diameter of the catalytic reactor 200 is at least 100 mm.

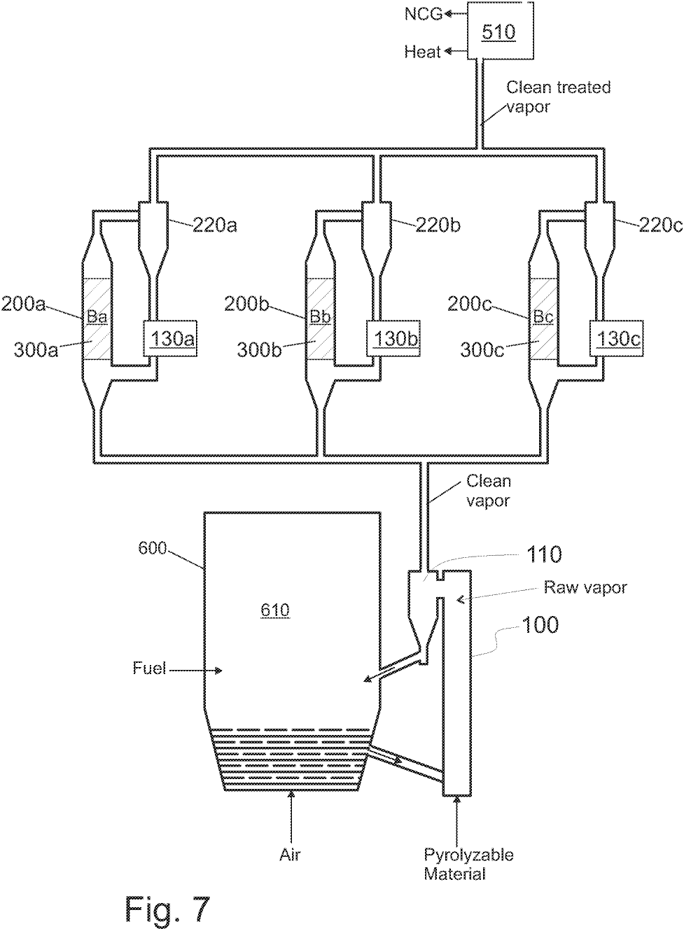

In order to keep the reactor 200 small and still have sufficient capacity, several catalytic reactors 200 may be used in parallel. In this way a diameter or a cross sectional area of each catalytic reactor 200 may be kept small, while simultaneously having a large total throughput, since the pyrolytic vapors would be treated in parallel reactors 200a, 200b simultaneously, as depicted in FIG. 7. Referring to FIG. 7, in an embodiment of the system, the aforementioned catalytic reactor 200 may be referred to as a first catalytic reactor 200a. Moreover, the embodiment comprises a second catalytic reactor 200b limiting a second bed area Bb into which a second fluidized catalyst bed is configured to form in use. What has been said about the catalytic reactor 200 applies to the first and second catalytic reactors 200a, 200b mutatis mutandis. As indicated in FIG. 7, the second catalytic reactor 200b comprises a second static mixer 300b configured to spread the particulate catalyst within the second bed area Bb. Each one of the catalytic reactors (200a, 200b, 200c) may comprise its own cyclone 220a, 220b, 220c, respectively. In the alternative, a same cyclone may be used to separate solids received from multiple catalytic reactors (not shown). Individual regenerators (130a, 130b, 130c) may be configured to regenerate catalyst receivable from one cyclone only, as in FIG. 7. In the alternative, one regenerator 130 may be configured to receive and regenerate catalyst from catalytic reactors 200a, 200b, 200c. The system may comprise at least two catalytic reactors (200a, 200b). The system may comprise at least three catalytic reactors (200a, 200b, 200c). One further benefit of having at least two or at least three catalytic reactors in that one of them may be maintained while the other one (or other ones) are used for catalytic treatment of pyrolytic vapors.

In a corresponding method, the catalytic reactor 200, to which at least a clean part of the pyrolytic vapor and particulate catalyst is fed, may be called the first catalytic reactor 200a. The corresponding method further comprises feeding at least a clean part of the pyrolytic vapor and particulate catalyst into a second catalytic reactor 200b. What has been said above about the treatment of the catalytic vapors applies mutatis mutandis to the use of the first and second reactors 200a, 200b. In line with what has been discussed above in the context of only one reactor 200, the embodiment of the method comprises
fluidizing the pyrolytic vapor and the particulate catalysts in a bed areas (Ba, Bb) of the first and second catalytic reactors (200a, 200b),
in the first and second bed areas (Ba, Bb), allowing the pyrolytic vapor to chemically react in the presence of the particulate catalyst to produce a mixture of the particulate catalyst and catalytically treated pyrolytic vapor, and
in the bed areas (Ba, Bb), mixing the pyrolytic vapor and the particulate catalyst with first and second static mixers (300a, 300b), respectively. However, the pyrolytic vapor and the particulate catalysts need not be fluidized simultaneously in different reactors 200a, 200b, 200c. As detailed above, one of them may be maintained while the other one(s) is/are operated.

As detailed above, preferably, the pyrolysis reactor 100 is of the fluidized bed type. The pyrolysis reactor 100 may be a circulating fluidized bed reactor, as in FIGS. 1a and 1b, or the pyrolysis reactor 100 may be of the bubbling fluidized bed type, as in FIG. 1c. Pyrolytic vapor can be effective withdraw from the pyrolytic reactor 100 with the fluidizing gas. Having a fluidized pyrolysis reactor has the further effect that oftentimes the amount of clean pyrolytic vapor, which includes the fluidizing gas of the pyrolysis reactor 100, is sufficient for fluidizing also the catalyst bed of the catalytic reactor 200 without adding further fluidizing gas to the catalytic reactor 200. This is particularly true when the pyrolysis reactor 100 is a circulating fluidized bed pyrolysis reactor (FIGS. 1a and 1b, as well as 2a to 2d, 6 and 7). Having a circulating fluidized bed pyrolysis reactor 100 has the further technical effect that the char and other oxidizable residues of the pyrolysis may be burned in a furnace 610. The furnace 610 may be a furnace of a combustion plant 600. Thus, in the furnace 610, the oxygen content may be much higher than an oxygen content in the pyrolysis reactor 100. Air (“Air” in FIGS. 6 and 7) may be fed to the furnace 610 to enable combustion. The combustion plant 600 may be e.g. a fluidized bed boiler or another char burner. Further fuel (“fuel” in FIGS. 6 and 7) may be fed to furnace 610 to produce further heat, thereby heating the bed material, which is conveyed back to the pyrolysis reactor 100. In this way, the full heat value of the pyrolyzable material is utilized, in part for the pyrolytic vapor, and in part when the residue is burned in the furnace 610.

When the pyrolysis reactor 100 is fluidized, as in FIGS. 1a, 1b, 1c, 6, and 7, a first cyclone 110 is configured to separate solids from raw pyrolytic vapor to produce clean pyrolytic vapor. When the pyrolysis reactor 100 is of the circulating fluidized bed type, the separated solids comprise bed material of the pyrolysis reactor, and at least the bed material may be transferred back to the pyrolysis reactor, optionally via the furnace 610. When the pyrolysis reactor 100 is of the bubbling fluidized bed type, the separated solids need not be fed back to the pyrolysis reactor 100. Instead, they may be transferred to a furnace (of any type), e.g. a furnace of a boiler, e.g. to a furnace of a fluidized bed boiler. Thus, in an embodiment, the pyrolysis reactor 100 is a fluidized bed pyrolysis reactor, and the system comprises the first cyclone 110, the first cyclone being 110 configured to produce the clean pyrolytic vapor from raw pyrolytic vapor. Correspondingly, an embodiment of the method comprises feeding pyrolyzable material into the pyrolysis reactor 100; fluidizing the pyrolyzable material in the pyrolysis reactor 100; pyrolyzing the pyrolyzable material in the pyrolysis reactor 100 to produce raw pyrolytic vapor, and cleaning the raw pyrolytic vapor to produce the clean pyrolytic vapor. The raw pyrolytic vapor is preferably cleaned using the first cyclone 110. In particular, solid bed material may be used in addition to the pyrolyzable material to form the fluidized bed. Thus, an embodiment comprises feeding also solid bed material into the pyrolysis reactor 100 and fluidizing the pyrolyzable material and the solid bed material in the pyrolysis reactor. The bed material may be fed e.g. from the furnace 610. An embodiment comprises separating solids from the raw pyrolytic vapor and transferring at least a part of the separated solids back to the pyrolysis reactor 100.

As detailed above, used particulate catalyst may be collected from the catalytic reactor 200, in particular from the second outlet 224, which may be arranged in a second cyclone of the catalytic reactor 200. The catalyst to be used is fed into the catalytic reactor 200 through the second inlet 214. The catalyst to be used may comprise at least one of (i) a fresh particulate catalyst, (ii) the used catalyst as such, and (iii) regenerated used catalyst. In terms of costs, it is feasible to use at least the used catalyst. Some fresh catalyst may be added, if needed.

Referring to FIGS. 2a to 2d, in order to recirculate the catalyst, an embodiment of the system comprises a channel 122 for transferring at least some of the catalyst material from the second outlet 224 to the second inlet 214. The channel 122 may comprise a first part for transferring at least some of the catalyst material from the second outlet 224 to a regenerator 130; and a second part for transferring at least some of the catalyst material from the regenerator 130 to the second inlet 214. Regarding the method, an embodiment comprises separating the particulate catalyst from the mixture of the catalyst and catalytically treated pyrolytic vapor and feeding at least some of the separated particulate catalyst into the catalytic reactor 200. However, the catalyst may be e.g. regenerated before feeding back into the reactor 200. In order to facilitate feeding of the particulate catalyst into the catalytic reactor 200, an embodiment comprises a conveyor 216, such as a screw conveyor, configured to convey particulate catalyst into the catalytic reactor 200 through the second inlet 214. Such a conveyor is depicted e.g. in FIGS. 1a to 1d, and can be used in connection with any embodiment. As for the structural details of the conveyor 216, the conveyor is configured to convey particulate catalyst. As detailed above, an average particle size of the particulate catalyst may be e.g. from 1 µm to 1000 µm . More preferably particle sizes have been discussed above, and the conveyor 216 may be configured to feed catalyst having that particle size. In case the catalytic reactor 200 comprise multiples inlets for letting in particulate catalyst into the catalytic reactor 200 (one of them being the second inlet 214) each one of those inlets may be provided with a conveyor configured to convey particulate catalyst into the catalytic reactor 200 through the inlet.

Preferably, at least some of the particulate catalyst that is recirculated is also regenerated. Therefore, an embodiment comprises a regenerator 130 configured to regenerate catalyst receivable from the second outlet 224. Such a regenerator 130 is shown in FIGS. 2c, 2d, 6, and 7 (regenerators 130a, 130b, 130c), but can be used in other embodiments, too. It is also possible to separate the regenerator 130 from the catalytic reactor 200. Thus, the used catalyst may be transferred from the second outlet 224 to the regenerator 130 via any suitable means (including channels, conveyors, and vehicles) and the regenerated catalyst may be transferred from the regenerator 130 to the second inlet 214 via any suitable means (including channels, conveyors, and vehicles). Regarding the method, an embodiment comprises regenerating at least part of the separated particulate catalyst and feeding the regenerated particulate catalyst into the catalytic reactor 200.

The treated pyrolytic vapors are oftentimes not used as such. Instead, they are condensed. Thus, an embodiment of the system comprises a condenser 510 configured to cool at least a part of the catalytically treated pyrolytic vapor and condense at least part of the catalytically treated pyrolytic vapor, as depicted in FIGS. 2a to 2d. Upon cooling, a part of the treated vapors condense. However, some of the compounds of the vapors do not condense. Such compounds are called non-condensable gas (NCG, see FIGS. 2c and 2d). The non-condensable gas may include the fluidizing gas of the pyrolysis and/or the catalysis. Correspondingly, at least some of the non-condensable gas may be fed into the pyrolysis reactor 100 and/or into the catalytic reactor 200. The recirculated NCG may serve the purpose of fluidizing the materials in at least in the bed area B of catalytic reactor 200 and optionally also in the pyrolysis reactor 100. The condensate resulting from the condensing is commonly referred to as “crude condensate” (see FIGS. 2c and 2d).

In this way, an embodiment of the method comprises cooling at least a part of the catalytically treated pyrolytic vapor and condensing at least part of the catalytically treated pyrolytic vapor to produce crude condensate and non-condensable gas. A preferable embodiment of the method comprises feeding the at least some of the non-condensable gas back to the process, e.g. into the pyrolysis reactor 100 and/or into the catalytic reactor 200.

Typically the crude condensate comprises water. However, water is in general not usable for the same purposes as the main pyrolysis product. Therefore, an embodiment of the system comprises a separator 515 configured to separate water from the crude condensate. As water is separated, the remainder can be called “bio-crude” (see FIG. 2d). An embodiment of the method comprises separating water from the crude condensate to produce bio-crude.

1-15. (canceled)

16. A system for producing catalytically treated pyrolytic vapor, the system comprising:
a pyrolysis reactor (100) configured to produce pyrolytic vapor, and
a catalytic reactor (200) limiting a bed area (B) into which a fluidized catalyst bed is configured to form in use, the catalytic reactor (200) comprising
a first inlet (212) for letting in at least a clean part of the pyrolytic vapor,
a second inlet (214) for letting in particulate catalyst,
a first outlet (222) for letting out catalytically treated pyrolytic vapor,
a second outlet (224) for letting out particulate catalyst, and
a static mixer (300) configured to spread the particulate catalyst within the bed area (B),
wherein the catalytic reactor (200) is configured to produce a mixture of the particulate catalyst and the catalytically treated pyrolytic vapor from the pyrolytic vapor.

17. The system of claim 16, wherein the static mixer (300) is made of a metal capable of withstanding a temperature of at least 400° C.

18. The system of claim 16, wherein:
in the bead area (B), the pyrolytic vapor is configured to flow, on average, in an axial direction (AX) of the catalytic reactor (200), and
the static mixer (300) comprises a primary first baffle plate (312, 392), arranged such that a primary first angle (a11, a91) between a normal (N11, N91) of the primary first baffle plate (312, 392) and the axial direction AX is at most 85 degrees, and the primary first baffle plate (312, 392) extends from a wall of the bed area (B) of the catalytic reactor (200) to an interior of the bed area (B).

19. The system of claim 18, wherein:
a full cross section of the bed area (B) of the catalytic reactor (200) is covered by a set of baffle plates, and
the set of baffle plates comprises the primary first baffle plate (312, 392).

20. The system of claim 16, further comprising a third inlet (104) for letting in fluidizing gas to increase flow of gas or gases in the bed area (B) of the catalytic reactor (200).

21. The system of claim 20, wherein the third inlet (104) is configured to let the fluidizing gas in to the pyrolysis reactor (100).

22. The system of claim 16, further comprising a conveyor (216), such as a screw conveyor, configured to convey the particulate catalyst into the catalytic reactor (200) through the second inlet (214).

23. The system of claim 22, wherein the conveyor (216) is configured to convey such particulate catalyst into the catalytic reactor (200), of which average particle size by volume is from 1 mm to 1000 mm.

24. The system of claim 16, wherein the catalytic reactor (200) comprises a particle separator configured to separate the particulate catalyst from the mixture of the particulate catalyst and catalytically treated pyrolytic vapor.

25. The system of claim 24, wherein:
the particle separator comprises a cyclone (220) configured to separate the particulate catalyst from the mixture of the particulate catalyst and catalytically treated pyrolytic vapor, and
the cyclone (220) comprises the first and second outlets (222, 224).

26. The system of claim 18, wherein:
the static mixer (300) comprises a primary second baffle plate (314), disposed at an angle relative to the primary first baffle plate (312),
the primary first angle (a11) is from 30 to 85 degrees, and
a primary second angle (a12) of from 30 to 85 degrees is arranged between a normal (N12) of the primary second baffle plate (314) and the axial direction (AX).

27. The system of claim 26, wherein a cross section of the bed area (B) is circular and the primary first and primary second baffle plates (312, 314) are semielliptical.

28. The system of the claim 26, wherein:
a primary distance (d1) is arranged between the first inlet (212) and at least a part of the primary first baffle plate (312) and
the primary distance (d1) is arranged between the first inlet (212) and at least a part of the primary second baffle plate (314); and the static mixer (300) comprises
a secondary first baffle plate (322) and a secondary second baffle plate (324), disposed at an angle relative to each other and at an angle from the axial direction (AX) of the catalytic reactor (200), wherein
a secondary distance (d2) is arranged between the first inlet (212) and at least a part of the secondary first baffle plate (322),
the secondary distance (d2) is arranged between the first inlet (212) and at least a part of the secondary second baffle plate (324), and
the secondary distance (d2) is greater than the first distance (d1).

29. The system of claim 18, wherein the primary first baffle plate (392) limits perforations (380) configured to pass both the pyrolytic vapor and the particulate catalyst.

30. The system of claim 29, wherein at least one of:
a normal (N91) of the perforated plate forms an angle of at most 10 degrees with the axis (AX) of the catalytic reactor (200);
the static mixer (300) comprises a primary second baffle plate (394) that limits perforations (380) and is configured to pass both the pyrolytic vapor and the particulate catalyst, wherein
a primary distance (d1) is arranged between the first inlet (212) and at least a part of the primary first baffle plate (392),
a secondary distance (d2) is arranged between the first inlet (212) and at least a part of the primary second baffle plate (394), or
the secondary distance (d2) is greater than the primary distance (d1).

31. The system of claim 30, wherein a total cross-sectional area of the perforations (380) of the primary first baffle plate (392) is from 30 % to 60 % of a cross sectional area of the bed area (B) of the catalytic reactor (200).

32. The system of claim 16, further comprising a regenerator (130) configured to regenerate particulate catalyst receivable from the second outlet (224).

33. The system of claim 32, further comprising means, such as a channel (122), for transferring at least some of the particulate catalyst from the second outlet (224) to the regenerator (130) and from the regenerator (130) to the second inlet (214).

34. The system of claim 16, further comprising a condenser (510) configured to cool at least a part of the catalytically treated pyrolytic vapor and condense at least part of the catalytically treated pyrolytic vapor.

35. The system of claim 34, further comprising means for conveying non-condensable gas from the condenser (510) into at least one of the pyrolysis reactor (100) and the catalytic reactor (200).

36. A method for producing catalytically treated pyrolytic vapor, the method comprising the steps of:
producing pyrolytic vapor,
feeding at least a clean part of the pyrolytic vapor and particulate catalyst into a catalytic reactor,
fluidizing the pyrolytic vapor and the particulate catalyst in a bed area of the catalytic reactor,
allowing the pyrolytic vapor to chemically react in the presence of the particulate catalyst to produce a mixture of the particulate catalyst and catalytically treated pyrolytic vapor, and
in the bed area, mixing the pyrolytic vapor and the particulate catalyst with a static mixer.

37. The method of claim 36, wherein the clean part of the pyrolytic vapor is produced by:
feeding pyrolyzable material into a pyrolysis reactor,
fluidizing the pyrolyzable material in the pyrolysis reactor,
pyrolyzing the pyrolyzable material in the pyrolysis reactor to produce raw pyrolytic vapor, and
cleaning the raw pyrolytic vapor to produce the clean part of the pyrolytic vapor.

38. The method of claim 36, wherein at least one of:
the particulate catalyst comprises zeolite; or
an average particle size of the particulate catalyst by volume is from 1 mm to 1000 mm.
